(19) United States
(12) Patent Application Publication
(10) Pub. No.: US 2013/0142388 A1
(43) Pub. Date: Jun. 6, 2013

(54) ARRIVAL TIME ESTIMATION DEVICE, ARRIVAL TIME ESTIMATION METHOD, ARRIVAL TIME ESTIMATION PROGRAM, AND INFORMATION PROVIDING APPARATUS

(71) Applicant: Honda elesys Co., Ltd., Yokohama-shi (JP)

(72) Inventor: Takahiro AZUMA, Yokohama-shi (JP)

(73) Assignee: Honda elesys Co., Ltd., Yokohama-shi (JP)

(21) Appl. No.: 13/666,707

(22) Filed: Nov. 1, 2012

(30) Foreign Application Priority Data
Nov. 2, 2011 (JP) 2011-241466

(51) Int. Cl. G06K 9/00

(52) U.S. Cl. CPC G06K 9/00
USPC 382/103

(57) ABSTRACT

An arrival time estimation device includes an image input unit configured to input an image signal to each frame, an object detecting unit configured to detect an object indicated by the image signal input through the image input unit, and an arrival time calculating unit configured to calculate a rotation matrix indicating rotation of an optical axis of an imaging device that captures the image signal based on a direction vector indicating a direction to the object detected by the object detecting unit, to calculate a change in a distance to the object based on a vector obtained by multiplying a past direction vector by the calculated rotation matrix and a current direction vector, and to calculate an arrival time to the object based on the calculated distance change.

### CROSS-REFERENCE TO RELATED APPLICATIONS

Priority is claimed on Japanese Patent Application No. 2011-241466 filed Nov. 2, 2011, the contents of which are entirely incorporated herein by reference.

### BACKGROUND OF THE INVENTION

1. Field of the Invention

The present invention relates to an arrival time estimation device, an arrival time estimation method, an arrival time estimation program, and an information providing apparatus.

2. Related Art

A technique has been proposed that provides peripheral information of a vehicle to a driver to safely drive the vehicle that travels on a road surface. As an example of the peripheral information, a process of performing detection based on an image obtained by photographing an obstacle that is present in a traveling direction using a vehicle-mounted camera has been proposed. In this regard, there is a technique that extracts a plurality of feature points on a subject indicated by the captured image and calculates change in the distance between the extracted feature points to estimate an arrival time to the subject.

For example, a collision time calculation apparatus disclosed in JPA-2006-107422 (Patent Document 1) extracts arbitrary two points that belong to the same object on an image captured by a camera as evaluation points, calculates a time-differential value of an absolute value of a difference between coordinate values of the extracted two points with reference to arbitrary coordinate axes set on the image, and calculates time that is necessary until the object including the extracted two points collides with an imaging surface of the camera based on the absolute value of the difference between the coordinate values of two points and the time-differential value.

### SUMMARY OF THE INVENTION

However, according to the collision time calculation apparatus disclosed in Patent Document 1, the extracted two points should be present on the same object and should be present at equal distances. Furthermore, in a case where the object is small in size, there is a case where two or more evaluation points are not obtained. Thus, it is difficult to reliably estimate an arrival time to the object.

An advantage of some aspects of the invention is to provide an arrival time estimation device, an arrival time estimation method, an arrival time estimation program, and an information providing apparatus that are capable of reliably estimating an arrival time to an object.

(1) According to a first aspect of the invention, there is provided an arrival time estimation device including: an image input unit configured to input an image signal to each frame; an object detecting unit configured to detect an object indicated by the image signal input through the image input unit; and an arrival time calculating unit configured to calculate a rotation matrix indicating rotation of an optical axis of an imaging device that captures the image signal based on a direction vector indicating a direction to the object detected by the object detecting unit, to calculate a change in a distance to the object based on a vector obtained by multiplying a past direction vector by the calculated rotation matrix and a current direction vector, and to calculate an arrival time to the object based on the calculated distance change.

(1) According to a second aspect of the invention, the arrival time estimation device according to (1) further includes a feature point extracting unit configured to extract a feature point on the object detected by the object detecting unit from the image signal input through the image input unit, and the arrival time calculating unit calculates an arrival time using the direction of the feature point extracted by the feature point extracting unit as the direction to the object.

(3) According to a third aspect of the invention, there is provided an information providing apparatus including: an image input unit configured to input an image signal to each frame; an object detecting unit configured to detect an object indicated by the image signal input through the image input unit; an arrival time estimating unit configured to calculate a rotation matrix indicating rotation of an optical axis of an imaging device that captures the image signal based on a direction vector indicating a direction to the object detected by the object detecting unit, to calculate a change in a distance to the object based on a vector obtained by multiplying a past direction vector by the calculated rotation matrix and a current direction vector, and to calculate an arrival time to the object based on the calculated distance change; and an output determining unit configured to determine whether to output information indicating arrival at the object detected by the object detecting unit based on an arrival time calculated by the arrival time calculating unit.

(4) According to a fourth aspect of the invention, there is provided an arrival time estimation method in an arrival time estimation device, the method including: receiving an input of an image signal for each frame, by the arrival time estimation device; detecting an object indicated by the image signal input through the image input unit, by the arrival time estimation device; and calculating a rotation matrix indicating rotation of an optical axis of an imaging device that captures the image signal based on a direction vector indicating a direction to the detected object, calculating a change in a distance to the object based on a vector obtained by multiplying a past direction vector by the calculated rotation matrix and a current direction vector, and calculating an arrival time to the object based on the calculated distance change, by the arrival time estimation device.

(5) According to a fifth aspect of the invention, there is provided an arrival time estimation program that causes a computer of an arrival time estimation device to execute a routine including: receiving an input of an image signal for each frame, by the arrival time estimation device; detecting an object indicated by the image signal input through the image input unit, by the arrival time estimation device; and calculating a rotation matrix indicating rotation of an optical axis of an imaging device that captures the image signal based on a direction vector indicating a direction to the detected object, calculating a change in a distance to the object based on a vector obtained by multiplying a past direction vector by the calculated rotation matrix and a current direction vector, and calculating an arrival time to the object based on the calculated distance change.

According to the invention, it is possible to reliably estimate an arrival time to an object.

### BRIEF DESCRIPTION OF THE DRAWINGS

FIG. 1 is a diagram schematically illustrating a configuration of an information providing apparatus according to an embodiment of the invention.

FIG. 2 is a conceptual diagram illustrating an example of an image signal according to an embodiment of the invention.

FIG. 3 is a conceptual diagram illustrating an example of the position relationship between a host vehicle and a feature point according to an embodiment of the invention.

FIG. 4 is a conceptual diagram illustration an example of the position relationship between an imaging surface of a camera and a feature point according to an embodiment of the invention.

FIG. 5 is a conceptual diagram illustrating an example of a time change in a camera coordinate system according to an embodiment of the invention.

FIG. 6 is a flowchart illustrating an information providing process according to an embodiment of the invention.

FIG. 7 is a flowchart illustrating a feature point search process according to an embodiment of the invention.

### DETAILED DESCRIPTION OF THE INVENTION

### First Embodiment

Hereinafter, embodiments of the invention will be described with reference to the accompanying drawings.

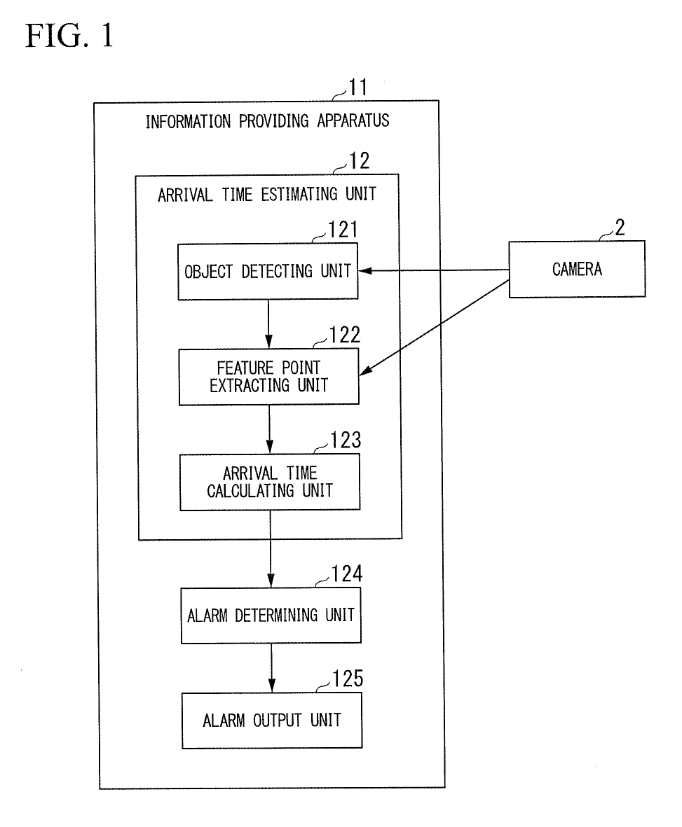

An arrival time estimation device according to an embodiment of the invention receives an input of an image signal for each frame, and detects an object indicated by the input image signal. Furthermore, the arrival time estimation device calculates a rotation matrix indicating rotation of an optical axis of an imaging device that captures the image signal based on a direction vector indicating a direction to the detected object, calculates a change in the distance to the object based on a vector obtained by multiplying a past direction vector by the calculated rotation matrix and a current direction vector, and calculates an arrival time to the object based on the calculated distance change. Furthermore, the information providing apparatus according to the present embodiment includes a configuration of the arrival time estimation device, and determines whether to output information indicating arrival at the detected object based on the calculated arrival time. FIG. 1 is a diagram schematically illustrating a configuration of an information providing apparatus 11 according to the present embodiment.

The information providing apparatus 11 includes an arrival time estimating unit 12, an alarm determining unit 124, and an alarm output unit 125.

A camera 2 captures a peripheral image at a predetermined time interval (for example, 1/30 seconds), and outputs the captured image to the arrival time estimating unit 12. Here, the “frame” is a unit of an image signal indicating a single image. An image signal of one frame includes a luminance value every pixel. The camera 2 is a vehicle video camera that is installed so that the direction of an optical axis is directed in front of a host vehicle mounted with the information providing apparatus 11. Thus, the camera 2 captures an image in front of the vehicle and generates an image signal.

The arrival time estimating unit 12 receives an input of the image signal from the camera 2 at the above-mentioned time interval for each frame. The arrival time estimating unit 12 detects an object indicated by the input image signal, and calculates an arrival time until arrival at the detected object. A process in which the arrival time estimating unit 12 calculates the arrival time will be described later. The arrival time estimating unit 12 outputs arrival time information indicating the calculated arrival time to the alarm determining unit 124. A configuration of the arrival time estimating unit 12 will be described later.

The alarm determining unit 124 determines whether to output an alarm indicating arrival at the detected object based on the arrival time information input from the arrival time estimating unit 12. When the input arrival time information is smaller than a preset time (for example, 30 seconds), the alarm determining unit 124 determines that the alarm is to be output. When it is determined that the alarm is to be output, the alarm determining unit 124 generates an alarm output request signal indicating that the alarm is to be output, and outputs the generated alarm output request signal to the alarm output unit 125.

When the alarm output request signal indicating that the alarm is to be output is input from the alarm determining unit 124, the alarm output unit 125 indicates the alarm information in a state of being recognizable by a user. For example, the alarm output unit 125 stores the alarm information in advance in a storage unit provided in the alarm output unit 125.

One example of the stored alarm information is a sound signal indicating the approach to the object, for example. When the alarm output request signal is input, the alarm output unit 125 reads the sound signal from the storage unit, and reproduces an alarm sound indicated by the read sound signal.

Another example of the stored alarm information is an image signal indicating an alarm screen that displays calling user's attention to circumstances, for example. When the alarm output request signal is input, the alarm output unit 125 reads the image signal from the storage unit, and displays the alarm screen indicated by the read image signal. Thus, it is possible to call user's attention, for example, driver's attention to circumstances, and to secure driving safety.

Next, a configuration of the arrival time estimating unit 12 will be described.

The arrival time estimating unit 12 includes an object detecting unit 121, a feature point extracting unit 122 and an arrival time calculating unit 123.

The object detecting unit 121 detects an object (for example, preceding vehicle, obstacle or the like) indicated by an image signal input from the camera 2, and generates object information indicating a region indicated by the detected object. The object detecting unit 121 performs edge detection, for example, in order to generate the object information. In a case where the edge detection is performed, the object detecting unit 121 spatially smoothes the input image signal and removes a component in which a spatial frequency is higher than a predetermined threshold value. The object detecting unit 121 calculates an absolute value of a gradient (in a horizontal direction and a vertical direction) between adjacent pixels included in the smoothed image as an index value, for each pixel. The object detecting unit 121 detects pixels in which the calculated index value is larger than a predetermined threshold value as edges. The object detecting unit 121 determines a region that is spatially surrounded by the detected edges as a region occupied by one object, and generates information for identifying each object for each determined region as the object information.

The object detecting unit 121 extracts object information about an object (for example, preceding vehicle) that is an observation target from the generated object information. The object detecting unit 121 extracts object information about an object that occupies a predetermined region of the image signal (for example, a region that includes a pixel present at the center of a frame and a predetermined number of pixels that are adjacent to the pixel), for example. The object detecting unit 121 outputs the object information about the extracted object to the feature point extracting unit 122.

The feature point extracting unit 122 receives an input of the image signal from the camera 2 for each frame, and receives an input of the object information from the object detecting unit 121.

The feature point extracting unit 122 extracts a feature point the region occupied by the object indicated by the object information, from the image signal. The feature point represents a point in an image from which an object moving to the vicinity can be uniquely determined. For example, the feature point corresponds to a luminance peak point or a contour corner point. The feature point extracting unit 122 may extract the feature point using the Harris method (reference: C. Harris and M. Stephens, “A combined corner and edge detector,” Proc. 4^{th} Alvey Vision Conf., pp. 147-151, Manchester, U.K., August 1988). In a case where the Harris method is used, the feature point extracting unit 122 calculates a Harris operator Mc as an index value indicating the size of gradient in respective coordinates (i, j) of the image signal. The Harris operator Mc is expressed by Equation (1).

M_{c}=det(A)−κ·trace²(A) (1)

In Equation (1), “det (A)” represents a determinant of a matrix A. Furthermore, “trace (A)” represents the sum of traces of the matrix A, that is, diagonal components. “κ” is a predetermined real number, for example, 0.04. The matrix A is the Harris matrix. Each component of the Harris matrix A is indicated by the following Equation (2), for example.

$$A = {\sum }_{u} {\sum }_{v} w ( u , v ) [ \begin{matrix}{I}_{x}^{2} & {I}_{x} {I}_{y} \\ {I}_{x} {I}_{y} & {I}_{y}^{2}\end{matrix} ] \qquad ( 2 )$$

In Equation (2), w(u, v) represents a window function indicating the weight of coordinates that are shifted by (u, v) from the respective coordinates (i, j). Iₓ is a difference value of luminance values at the coordinates (i, j) in the horizontal direction (x direction). The coordinates I_{y} is a difference value of luminance values at the coordinates (i, j) in the vertical direction (y direction).

The feature point extracting unit 122 extracts a predetermined number (for example, 10) of coordinates from a point where the calculated index value is the largest, as feature points. The feature point extracting unit 122 may extract coordinates in which the calculated index value is larger than a predetermined value, as the feature points.

The feature point extracting unit 122 outputs feature point information indicating the coordinates of the extracted feature points to the arrival time calculating unit 123.

The arrival time calculating unit 123 receives an input of the feature point information from the feature point extracting unit 122 for each frame. Here, the arrival time calculating unit 123 selects a feature point of a previous frame k−1 (k is an integer indicating a frame time) corresponding to the feature point indicated by the feature point information, from a feature point of a current frame k indicated by the feature point information. An example of a feature point selecting process according to the present embodiment will be described later.

The arrival time calculating unit 123 calculates a direction vector pₖ₋₁ to the selected feature point in the previous frame k−1 and a direction vector pₖ to a corresponding feature point in the current frame k.

The direction vectors pₖ₋₁ and pₖ calculated by the arrival time calculating unit 123 are expressed by a camera coordinate system based on the camera 2, as shown in Equation (3), for example. The coordinate system is a 3D orthogonal coordinate system that uses a position where the camera 2 is installed as the origin and has coordinate axes in a horizontal direction and a vertical direction, and an optical axis direction of an image captured in an imaging device. Accordingly, the position of the origin of the coordinate system is changed in accordance with traveling of the vehicle.

$${p}_{k - 1} = [ \begin{matrix}x \\ y \\ 1\end{matrix} ] , {p}_{k} = [ \begin{matrix}{x}^{′} \\ {y}^{′} \\ 1\end{matrix} ] \qquad ( 3 )$$

In Equation (3), x is a normalized coordinate value obtained by multiplying the coordinate (pixel index) of the feature point in the previous frame k−1 in the horizontal direction by a correction coefficient n_{f} obtained by dividing an interval d between pixels of the camera 2 by a focal distance f. Here, y is a normalized coordinate value obtained by multiplying the coordinate of the feature point in the previous frame k−1 in the horizontal direction by the correction coefficient n_{f}. Here, x′ is a normalized coordinate value obtained by multiplying the coordinate of the feature point in the current frame k in the horizontal direction by the correction coefficient n_{f}. y′ is a normalized coordinate value obtained by multiplying the coordinate of the feature point in the current frame k in the vertical direction by the correction coefficient n_{f}. In the arrival time calculating unit 123, the interval d between pixels and the focal distance f, or the correction coefficient n_{f} is set in advance as a camera parameter of the camera 2.

Here, the position change of the feature point will be described.

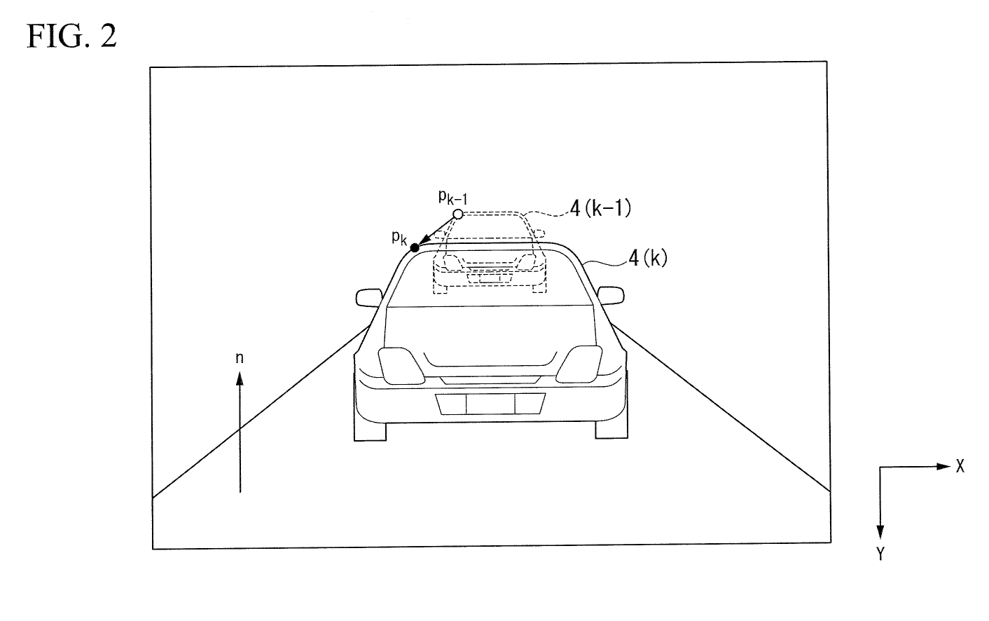

FIG. 2 is a conceptual diagram illustrating an example of an image signal.

In FIG. 2, the left and right direction represents the horizontal direction (x axis), the up and down direction represents the vertical direction (y axis). FIG. 2 shows an image displayed by overlapping an image captured in the previous frame k−1 with an image captured in the current frame k.

The figure indicated by a dashed line in a central upper portion of FIG. 2 represents an image indicating a preceding vehicle 4 (preceding vehicle 4 (k−1)) that is a subject photographed in the previous frame k−1. The preceding vehicle 4 is a vehicle that travels in a traveling direction of a host vehicle 3 that is mounted with the information providing apparatus 1 and the camera 2. The white circle represents a feature point in the previous frame k−1. The figure indicated by a solid line in a central lower portion of FIG. 2 represents an image indicating the preceding vehicle 4 (preceding vehicle 4 (k)) that is a subject photographed in the current frame k. The black circle represents a feature point in the current frame k. The arrow drawn from the white circle to the black circle indicates that the feature point indicated by the white circle corresponds to the feature point indicated by the black circle. That is, the arrow represents movement of the feature point from the previous frame k−1 to the current frame k. Furthermore, an upward arrow shown in a left lower portion of FIG. 2 represents a normal vector n. The normal vector n represents a vector indicating a vertical direction with respect to a road surface on which the host vehicle 3 travels. In the present embodiment, the normal vector n is set in advance in the arrival time calculating unit 123.

Returning to FIG. 1, the arrival time calculating unit 123 calculates a rotation matrix R based on the calculated vectors pₖ₋₁ and pₖ. The rotation matrix R represents that the coordinate axes of the camera coordinate system in the previous frame k−1 are rotated into the coordinate axes of the camera coordinate system in the current frame k. An example of a method of calculating the rotation matrix R in the present embodiment will be described later.

Next, the relationship between the direction vectors pₖ₋₁ and pₖ and the rotation matrix R will be described.

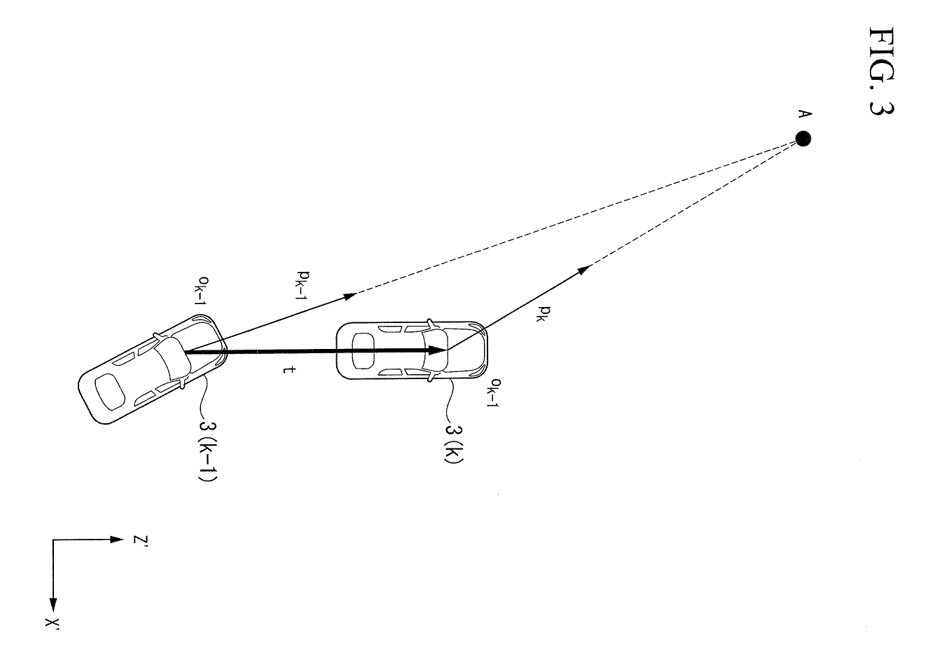

FIG. 3 is a conceptual diagram illustrating an example of the position relationship between the host vehicle 3 and the feature point in the present embodiment.

The left and right direction in FIG. 3 represents a direction (X′ direction) that is perpendicular to the optical axis direction of the camera 2 in the current frame k and is in parallel with the road surface. The up and down direction in FIG. 3 represents the optical axis direction (Z′ direction) of the camera 2 in the current frame k.

The figure shown in a lower portion of FIG. 3 represents the host vehicle 3 (host vehicle 3 (k−1)) in the previous frame k−1. oₖ₋₁ represents the origin of the coordinates in the previous frame k−1, that is, the position of the camera 2. The arrow that directs leftward and upward from the starting point of oₖ₋₁ represents the direction vector pₖ₋₁. The figure shown in a central portion of FIG. 3 represents the host vehicle 3 (host vehicle 3 (k)) in the previous frame k. oₖ represents the origin of the coordinates in the current frame k, that is, the position of the camera 2. The arrow that directs leftward and upward from the starting point of oₖ represents the direction vector pₖ. The black circle shown in an upper left portion of FIG. 3 represents a feature point A. The arrow that directs from oₖ₋₁ to oₖ represents a translation vector t. That is, FIG. 3 shows that the feature point A is stationary and the camera 2 is relatively moving.

Next, the relationship between the direction vectors pₖ₋₁ and pₖ and the image indicating the feature point A will be described.

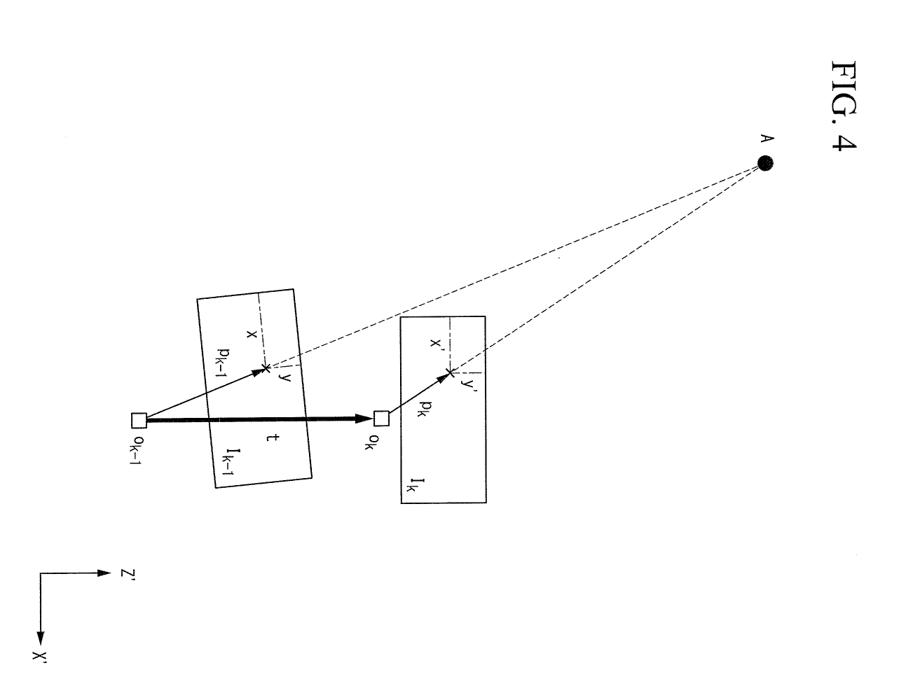

FIG. 4 is a conceptual diagram illustrating an example of the position relationship between the imaging surface of the camera 2 and the feature point in the present embodiment.

The up and down directions, the left and right directions, the feature point A, the origins oₖ₋₁ and oₖ, the direction vectors pₖ₋₁ and pₖ and the translation vector t shown in FIG. 4 are the same as in FIG. 3.

Here, a mark x that is the terminal point of the direction vector pₖ₋₁ represents the position of the feature point A in an imaging surface Iₖ₋₁. The imaging surface Iₖ₋₁ represents an image captured by the camera 2 in the previous frame k−1. x represents a normalized coordinate of the feature point A in the horizontal direction, as described above. y represents a normalized coordinate of the feature point A in the vertical direction, as described above.

Here, a mark x that is the terminal point of the direction vector pₖ represents the position of the feature point A in an imaging surface Iₖ. The imaging surface Iₖ represents an image captured by the camera 2 in the current frame k. x′ represents a normalized coordinate of the feature point A in the horizontal direction, as described above. y′ represents a normalized coordinate of the feature point A in the vertical direction, as described above.

Next, a time change of the above-described camera coordinate system will be described.

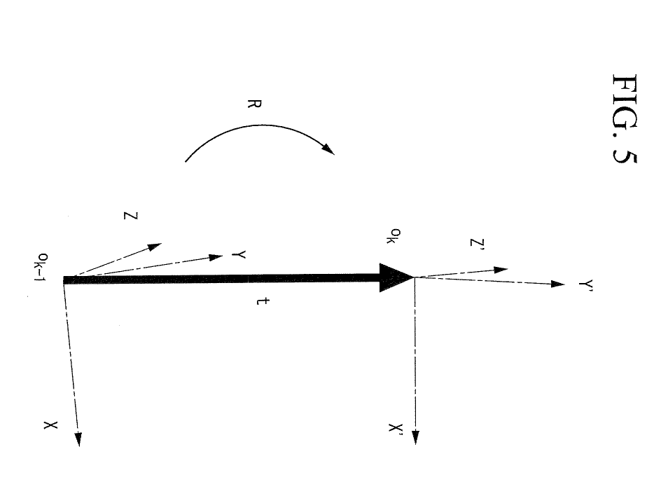

FIG. 5 is a conceptual diagram illustrating an example of the time change of the camera coordinate system according to the present embodiment.

The up and down directions, the left and right directions, the origins oₖ₋₁ and oₖ, and the translation vector t shown in FIG. 5 are the same as in FIG. 3 and FIG. 4.

A lower central portion of FIG. 5 represents coordinate axes of the camera coordinate system of the camera 2 in the previous frame k−1. The Z axis direction represents the optical axis direction of the camera 2. The X axis direction represents a direction that is perpendicular to the optical axis direction of the camera 2 and is in parallel with the horizontal plane. The Y axis direction represents a direction that is perpendicular to the optical axis direction of the camera 2 and is perpendicular to the X axis direction.

A central portion of FIG. 5 represents coordinate axes of the camera coordinate system of the camera 2 in the current frame k. The respective X′, Y′ and Z′ axis directions are the same as in FIG. 3.

A clockwise arrow present on the left side of the translation vector t represents a direction in which the camera coordinate system is rotated from the previous frame k−1 to the current frame k. The rotation matrix R is a matrix that quantitatively represents this rotation.

As shown in FIG. 3, the direction vector pₖ satisfies the following relationship with the rotation matrix R and the direction vector pₖ₋₁.

Z′pₖ=R(Zpₖ₋₁)+t (4)

In Equation (4), Z represents the coordinate of the camera 2 in the optical axis direction in the previous frame k−1. Z′ represents the coordinate of the camera 2 in the optical axis direction in the current frame k. t represents the translation vector indicating the difference between the origin oₖ₋₁ in the previous frame k−1 and the origin oₖ in the current frame k, that is, the difference between the positions of the camera 2.

The arrival time calculating unit 123 calculates a ratio Z′/Z of the distance Z′ in the current frame k to the distance Z in the previous frame k−1, based on the calculated rotation matrix R. Here, the distance Z′ represents a coordinate value of the feature point in the current frame k in the optical axis direction of the camera 2. The distance Z represents a coordinate value of the feature point in the previous frame k−1 in the optical axis direction of the camera 2.

That is, the distance ratio Z′/Z is an index value indicating a change rate of the distance of the feature point from the previous frame k−1 to the current frame k, that is, from the camera 2 to the subject. When, the distance ratio Z′/Z has a value that is larger than 0 and smaller than 1, this means that the camera 2 approaches the subject. Here, as the distance ratio Z/Z′ is small, this means that the camera 2 approaches the subject early. In a case where the distance ratio Z′/Z is 1, this means that the distance to the subject is not changed. In a case where the distance ratio Z′/Z is larger than 1, this means that the camera 2 becomes distant from the subject. In this regard, in a case where the distance ratio is 0 or a negative value, the arrival time calculating unit 123 determines this case as an error, and stops the process in the current frame k.

When calculating the distance ratio Z′/Z, the arrival time calculating unit 123 uses Equation (5), for example.

Z′/Z=n^{T}Rpₖ₋₁/n^{T}pₖ (5)

In Equation (5), T represents an operator indicating transposition of a vector or a matrix. Equation (5) represents that the ratio of an inner product of a vector Rpₖ₋₁ corrected by multiplying the direction vector pₖ₋₁ by the rotation matrix R and the normal vector n to an inner product of the direction vector pₖ and the normal vector n is calculated as the distance ratio Z′/Z.

A principle of calculating the distance ratio Z′/Z using Equation (5) will be described later.

The arrival time calculating unit 123 calculates an arrival time TTC based on the distance ratio Z′/Z, using Equation (6), for example.

TTC=ΔT/(Z/Z′−1) (6)

In Equation (6), ΔT represents a time interval between frames. The numerator in Equation (6) represents a change rate of the distance from the camera 2 to the feature point on the object for each interval between frames. That is, Equation (6) represents that the number of frames until the camera 2 arrives at the feature point is normalized by the time interval between frames, that is, is calculated as an arrival time.

The arrival time calculating unit 123 outputs arrival time information indicating the calculated arrived time to the alarm determining unit 124.

Next, an information providing process according to the present embodiment will be described.

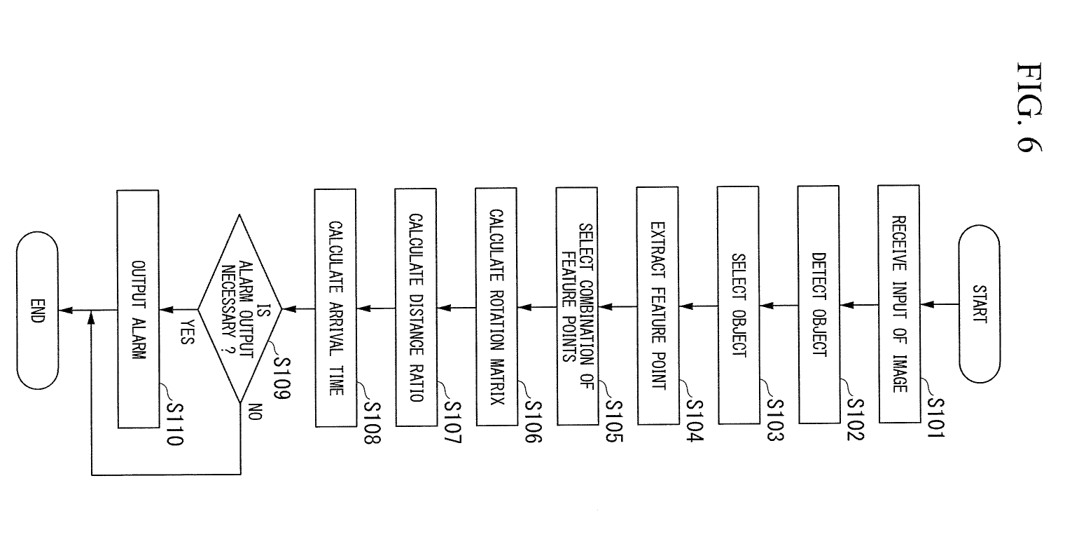

FIG. 6 is a flowchart illustrating the information providing process according to the present embodiment.

(Step S101) The object detecting unit 121 and the feature point extracting unit 122 receive an input of an image signal for each frame from the camera 2. Then, the procedure goes to step S102.

(Step S102) The object detecting unit 121 detects an object indicated by the image signal, and generates object information indicating a region indicated by the detected object. Then, the procedure goes to step S103.

(Step S103) The object detecting unit 121 extracts object information about an object (for example, preceding vehicle) that is an observation target, from the generated object information. The object detecting unit 121 outputs the extracted object information about the object to the feature point extracting unit 122. Then, the procedure goes to step S104.

(Step S104) The feature point extracting unit 122 extracts a feature point of a region indicated by the object indicated by the object information input from the object detecting unit 121, from the image signal input from the camera 2. The feature point extracting unit 122 outputs feature point information indicating coordinates of the extracted feature point to the arrival time calculating unit 123. Then, the procedure goes to step S105.

(Step S105) The arrival time calculating unit 123 selects a feature point of the previous frame k−1 corresponding to the feature point indicated by the feature point information, from a feature point of the current frame k indicated by the feature point information input from the feature point extracting unit 122. An example of a feature point selection process according to the present embodiment will be described later. Then, the procedure goes to step S106.

(Step S106) The arrival time calculating unit 123 calculates the direction vector pₖ₋₁ to the selected feature point in the previous frame k−1 and the direction pₖ to the corresponding feature point in the current frame k. The arrival time calculating unit 123 calculates the rotation matrix R based on the calculated direction vectors pₖ₋₁, and pₖ. Then, the procedure goes to step S107.

(Step S107) The arrival time calculating unit 123 calculates the distance ratio Z′/Z, for example, using Equation (5), based on the calculated direction vectors pₖ₋₁ and pₖ, and the rotation matrix R, and the normal vector n that is set in advance. Then, the procedure goes to step S108.

(Step S108) The arrival time calculating unit 123 calculates the arrival time TTC, for example, using Equation (6), based on the calculated distance ratio Z′/Z. The arrival time calculating unit 123 outputs arrival time information indicating the calculated arrival time TTC to the alarm determining unit 124. Then, the procedure goes to step S109.

(Step S109) The alarm determining unit 124 determines whether to output an alarm indicating arrival at the detected object based on the arrival time information input from the arrival time calculating unit 123. In a case where it is determined that the alarm is to be output (Y in step S109), the procedure goes to step S110. In a case where it is determined that the alarm is not to be output (N in step S109), the procedure ends.

(Step S110) When determining that the alarm is to be output, the alarm determining unit 124 generates an alarm output request signal, and outputs the generated alarm output request signal to the alarm output unit 125. When the alarm output request signal is input from the alarm determining unit 124, the alarm output unit 125 indicates alarm information in a state of being recognizable by a user. Then, the procedure ends.

Steps S101 to S108 among the above-described steps correspond to the arrival time calculation process according to the present embodiment.

Next, a process of searching the feature point in the previous frame k−1 corresponding to the feature point in the current frame k, performed by the arrival time calculating unit 123, in the present embodiment will be described.

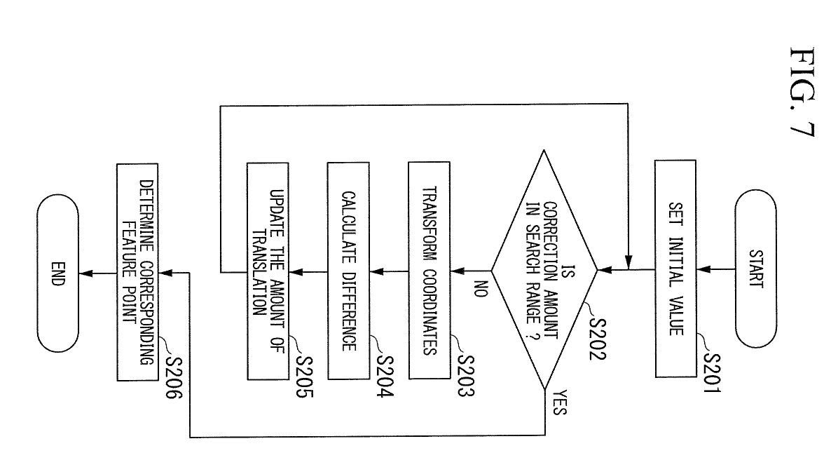

FIG. 7 is a flowchart illustrating the feature point searching process according to the present embodiment.

(Step S201) The arrival time calculating unit 123 sets an initial value of a translation vector of each feature point from the previous frame k−1 to the current frame k for each object to 0, for example. The arrival time calculating unit 123 may set the initial value to the amount of translation that is previously calculated (the amount of translation between feature points from a frame k−2 to a frame k−1, for example), instead of 0. Furthermore, the arrival time calculating unit 123 sets a range of searching the feature points of the previous frame k−1 from the feature points of the current frame k. Then, the procedure goes to step S202.

(Step S202) The arrival time calculating unit 123 determines whether the amount of translation of each feature point for each object is in a set range of values. When the arrival time calculating unit 123 determines that the amount of translation is in the set range of values (Y in step S202), the procedure goes to step S206. When the arrival time calculating unit 123 determines that the amount of translation for each object is not in the set range of values (N in step S202), the procedure goes to step S203.

(Step S203) The arrival time calculating unit 123 adds the amount of translation for each object to the coordinates of each feature point of the previous frame k−1 to estimate the coordinates of each feature point of the current frame t. Then, the procedure goes to step S204.

(Step 204) The arrival time calculating unit 123 calculates the difference between an interpolation pixel value of a sampling point that is present in an adjacent region (in the vicinity of the feature point) that is within a preset distance from the feature point in the current frame k estimated in step S203 and an interpolation pixel value of a sampling point that is in the vicinity of the feature point in the previous frame k−1, with respect to each sampling point. The sampling point of the previous frame k−1 represents a central point of respective pixels included in the vicinity of the feature point in the previous frame k−1, for example. The sampling point in the current frame k represents coordinates estimated by adding the amount of translation to the sampling point of the previous frame k−1.

Since the feature point should not necessarily be present on the central point of the respective pixels, the arrival time calculating unit 123 calculates the corresponding interpolation pixel value in each frame based on the position relationship between the central point of the respective pixels that are present in the vicinity of the feature point and the feature point. Then, the procedure goes to step S205.

(Step S205) The arrival time calculating unit 123 calculates the amount of translation that minimizes the sum of squares of the difference calculated in step S204, based on a nonlinear least-squares method, for example, to update the amount of translation. Then, the procedure goes to step S202.

(Step S206) The arrival time calculating unit 123 determines feature points of the previous frame k−1 in which the sum of squares based on the difference calculated in step S205 is minimum, as feature points of the previous frame k−1 respectively corresponding to the feature points of the current frame k. Here, the arrival time calculating unit 123 determines the amount of translation obtained in this process as the translation vector t. Then, the procedure ends.

Next, an example of a method of calculating the rotation matrix R in the present embodiment will be described.

The rotation matrix R is a matrix of three rows and three columns shown in Equation (7), for example.

$$R = [ \begin{matrix}cos {θ}_{Z} & - sin {θ}_{Z} & 0 \\ sin {θ}_{Z} & cos {θ}_{Z} & 0 \\ 0 & 0 & 1\end{matrix} ] [ \begin{matrix}cos {θ}_{Y} & 0 & sin {θ}_{Y} \\ 0 & 1 & 0 \\ - sin {θ}_{Y} & 0 & cos {θ}_{Y}\end{matrix} ] [ \begin{matrix}1 & 0 & 0 \\ 0 & cos {θ}_{X} & - sin {θ}_{X} \\ 0 & sin {θ}_{X} & cos {θ}_{X}\end{matrix} ] \qquad ( 7 )$$

In Equation (7), θ_{z} represents a rotation angle at which the coordinate axis (Z′ axis) in the optical axis direction of the camera 2 in the current frame k is rotated. θₓ represents a rotation angle at which the coordinate axis (X′ axis) that is perpendicular to the optical axis direction of the camera 2 and is in parallel with the horizontal plane in the current frame k is rotated. θ_{y} represents a rotation angle at which the coordinate axis (Y′ axis) that is perpendicular to the optical axis direction of the camera 2 and is perpendicular to the X′ axis in the current frame k is rotated. Accordingly, a determinant of the rotation matrix R shown in Equation (7) becomes 1.

Furthermore, the direction vectors pₖ₋₁ and pₖ, the rotation matrix R and the translation vector t have the relationship expressed by Equation (8).

pₖ^{T}(t×R)pₖ₋₁=0 (8)

In Equation (8), “x” represents an outer product of three-dimensional vectors. The relationship expressed by Equation (8) is called the epipolar condition. That is, Equation (8) represents a condition where three three-dimensional vectors R, pₖ₋₁ and pₖ, and the translation vector t are present on the same plane. The outer product t×Rpₖ₋₁ represents a normal to a plane formed by the vectors t and Rpₖ₋₁, and represents, if the direction vector pₖ is also included in this plane, that the inner product of the direction vector pₖ and the normal is 0.

In this regard, the arrival time calculating unit 123 calculates the rotation matrix R and the translation vector t in which the sum of squares of the term on the left side of Equation (8) is minimum using a nonlinear least-squares method, for example, with respect to five or more feature points. Here, in the calculation process, the respective components of the rotation matrix R maintain the relationship expressed by Equation (7), for example. In this way, the arrival time calculating unit 123 is able to calculate the rotation matrix R.

Next, the principle that the arrival time calculating unit 123 calculates the distance ratio Z′/Z using Equation (5) will be described.

The translation vector t represents the difference between the position of the host vehicle 3 in the previous frame k−1 and the position of the host vehicle 3 in the current frame k. Thus, the translation vector t is approximately orthogonal to the normal vector n indicating the direction perpendicular to the road surface on which the host vehicle 3 travels.

Thus, if the inner product of the terms on both sides of Equation (4) and the normal vector n is performed, the second term on the right side of Equation (4) becomes 0 and Equation (9) is derived.

Z′n^{T}pₖ=Zn^{T}Rpₖ₋₁ (9)

Furthermore, if the terms on both sides of Equation (9) are divided by Z·n^{T}pₖ, it is possible to derive Equation (2).

In the above description, an example in which the arrival time calculating unit 123 calculates the arrival time until arrival at the object using the image signal and the image signal of the previous frame captured in the past by one frame (total two frames) has been described. In the present embodiment, the example is not limiting. For example, the arrival time calculating unit 123 may calculate an average value (for example, movement mean value) of the calculated arrival time TTC (k) at the current frame time k to an arrival time TTC (k-(M−1)) at a time k-(M−1) in the past by (M−1) frames, as the arrival time TTC (k) at the current frame time k. Thus, the influence due to convexes and concaves of the road surface on which the host vehicle 3 provided with the arrival time calculating unit 123 is positioned or convexes and concaves of the road surface on which the object (subject) travels is smoothed, and it is thus possible to calculate the arrival time TTC with high accuracy.

As described above, in the present embodiment, the image signal is input for each frame, the object indicated by the input image signal is detected, the rotation matrix indicating the rotation of the optical axis of the imaging device that captures the image signal is calculated based on the direction vector indicating the direction to the detected object, and the change in the distance to the object is calculated based on the vector obtained by multiplying the previous direction vector by the calculated rotation matrix and the current direction vector. Thus, even though the object is present at a distant position in the traveling direction, an error based on a direction change of the object is suppressed. Thus, it is possible to enhance estimation accuracy of an arrival time to an object such as an obstacle.

Furthermore, in the present embodiment, it is determined whether to output the information indicating arrival at the detected object, based on the calculated arrival time.

Thus, it is possible to reliably notify the possibility of arrival at the detected object or the arrival time to a user.

A part of the information providing apparatus 11 in the above-described embodiment, for example, the object detecting unit 121, the feature point extracting unit 122, the arrival time calculating unit 123 and the alarm determining unit 124 may be realized by a computer. In this case, a program for realizing the control function may be recorded on a computer-readable recording medium, and the program recorded on the recording medium may be read by a computer system for execution. Here, the “computer system” may be a computer system built in the information providing apparatus 11, and may include hardware such as an OS or peripherals. Furthermore, the “computer-readable recording medium” refers to a movable medium such as a flexible disk, a magneto-optical disc, a ROM or a CD-ROM, or a storage device such as a hard disk built in the computer system. Furthermore, the “computer-readable recording medium” may include a medium that dynamically stores a program for a short time, such as a communication cable in a case where the program is transmitted through a network such as the interne or a communication line such as a telephone line, or a medium that stores, in this case, the program for a specific time, such as a volatile memory inside a computer system including a server and a client. Furthermore, the program may be a program that realizes a part of the above-described functions, or may be a program that realizes the above-described functions by combination with a program that is recorded in advance in the computer system.

Furthermore, a part or the entire of the information providing apparatus 11 according to the above-described embodiment may be realized as an integration circuit such as an LSI (Large Scale Integration). The respective function blocks of the information providing apparatus 11 may be individually realized as a processor, or a part or all thereof may be integrated into a processor. Furthermore, a method of realizing the integration circuit is not limited to the LSI, and may be realized as a dedicated circuit or a general purpose processor. Furthermore, in a case where an integration circuit technique as a replacement for the LSI appears according to technological advances, an integration circuit according to the technique may be used.

As described above, the embodiments of the invention have been described in detail with reference to the accompanying drawings, but a specific configuration is not limited to the above description, and various design changes may be made in a range without departing from the spirit of the invention.

What is claimed is:

1. An arrival time estimation device comprising:
an image input unit configured to input an image signal to each frame;
an object detecting unit configured to detect an object indicated by the image signal input through the image input unit; and
an arrival time calculating unit configured to calculate a rotation matrix indicating rotation of an optical axis of an imaging device that captures the image signal based on a direction vector indicating a direction to the object detected by the object detecting unit, to calculate a change in a distance to the object based on a vector obtained by multiplying a past direction vector by the calculated rotation matrix and a current direction vector, and to calculate an arrival time to the object based on the calculated distance change.

2. The arrival time estimation device according to claim 1, further comprising:
a feature point extracting unit configured to extract a feature point on the object detected by the object detecting unit from the image signal input through the image input unit,
wherein the arrival time calculating unit calculates the arrival time using the direction of the feature point extracted by the feature point extracting unit as the direction to the object.

3. An information providing apparatus comprising:
an image input unit configured to input an image signal to each frame;
an object detecting unit configured to detect an object indicated by the image signal input through the image input unit;
an arrival time calculating unit configured to calculate a rotation matrix indicating rotation of an optical axis of an imaging device that captures the image signal based on a direction vector indicating a direction to the object detected by the object detecting unit, to calculate a change in a distance to the object based on a vector obtained by multiplying a past direction vector by the calculated rotation matrix and a current direction vector, and to calculate an arrival time to the object based on the calculated distance change; and
an output determining unit configured to determine whether to output information indicating arrival at the object detected by the object detecting unit based on an arrival time calculated by the arrival time calculating unit.

4. An arrival time estimation method in an arrival time estimation device, the method comprising:
receiving an input of an image signal for each frame, by the arrival time estimation device;
detecting an object indicated by the image signal input through the image input unit, by the arrival time estimation device; and
calculating a rotation matrix indicating rotation of an optical axis of an imaging device that captures the image signal based on a direction vector indicating a direction to the detected object, calculating a change in a distance to the object based on a vector obtained by multiplying a past direction vector by the calculated rotation matrix and a current direction vector, and calculating an arrival time to the object based on the calculated distance change, by the arrival time estimation device.

5. An arrival time estimation program that causes a computer of an arrival time estimation device to execute a routine comprising:
receiving an input of an image signal for each frame;
detecting an object indicated by the image signal input through the image input unit; and
calculating a rotation matrix indicating rotation of an optical axis of an imaging device that captures the image signal based on a direction vector indicating a direction to the detected object, calculating a change in a distance to the object based on a vector obtained by multiplying a past direction vector by the calculated rotation matrix and a current direction vector, and calculating an arrival time to the object based on the calculated distance change.
